(19) United States
(12) Patent Application Publication
(10) Pub. No.: US 2005/0241505 A1
(43) Pub. Date: Nov. 3, 2005

(54) Printing press and method for printing two webs

(76) Inventor: Jochen Emil Paul Schwab, ZELL AM MAIN (DE)

Correspondence Address: Douglas R Hanscom;Jones Tullar and Cooper, P O Box 2266, Eads Station, Arlington, VA, 22202, US

(21) Appl. No.: 10/522,151

(22) PCT Filed: Jul. 15, 2003
(86) PCT No.: PCT/DE03/02376

§ 371 Date: Jan. 24, 2005

(30) Foreign Application Priority Data
Aug. 2, 2002 (DE) 102 35 392.1

(51) Int. Cl. B41F 13/02; B41F 7/12

(52) U.S. Cl. 101/219; 101/217; 101/181

(57) ABSTRACT

Please add the Abstract of the Disclosure as set forth on the separate accompanying sheet. That Abstract of the Disclosure is essentially the same, in content, as the Abstract which is a part of the published PCT application WO 2004/016429 A1. No new matter is being added by the presentation of this Abstract of the Disclosure.

### CROSS-REFERENCE TO RELATED APPLICATIONS

This application is the U.S. national phase, under 35 USC 371, of PCT/DE2003/002376, filed Jul. 15, 2003, published as WO 2004/016429 A1 on Feb. 26, 2004, and claiming priority to DE 102 35 392.1, filed Aug. 2, 2002, the disclosures of which are expressly incorporated herein by reference.

### FIELD OF THE INVENTION

The present invention is directed to a printing press and to a method for imprinting two webs . The two webs are conducted back to back through a first printing group and then to a second printing group.

### BACKGROUND OF THE INVENTION

A printing press is known from DE 100 15 703 A1. Two webs are conducted back to back through several double printing groups and each is imprinted on one side. Each web can be conducted around respectively one of the double printing groups, which permits the imprinting of the other web on both sides.

It is known from DE 41 04 135 A1 to conduct a web in a double printing group between the forme and transfer cylinders, as well as between the two transfer cylinders, and to imprint one side of the web by the use of the forme cylinder by the so-called direct lithographic process, as well as by use of the offset method by the transfer cylinder of the second printing group.

DE 18 27 845 U shows a web which is selectively conducted either between two transfer cylinders, or between one transfer cylinder and an associated forme cylinder.

A web guidance through a printing press is known from CH 657 313 A5. Each one of two webs is imprinted, in accordance with a direct printing process, at several printing positions that are constituted by transfer cylinders and cooperating forme cylinders. In this mode of operation, the transfer cylinders of neighboring printing groups are disengaged from each other. The webs are guided through the printing positions separated from each other.

A printing press for the simultaneous imprinting of two webs is known from EP 0 919 373 A1. Two webs are conducted, back to back, through double printing groups and are each imprinted on one side. Thereafter, each one of the webs is individually imprinted on one or on both sides by respectively further offset printing groups.

### SUMMARY OF THE INVENTION

The object of the present invention is directed to providing a printing press and to providing a method for imprinting two webs.

In accordance with the present invention, this object is attained by conducting two webs back to back through a first double printing unit where each of the webs is printed on one side. An additional double printing group, having two single printing groups or units that are adapted for rubber-against-rubber printing, is provided. In the additional double printing group at least one of the webs is conducted between a transfer cylinder and an associated forme cylinder. It can be directly printed on one side by that forme cylinder.

The advantages which can be obtained by the present invention lie, in particular, in that it is possible, without a large additional outlay for technical installations, to considerably increase the productivity of the printing process in connection with the printing of certain products, for example to double it. This is particularly the case if at least one side of the web only needs to be singly imprinted, i.e. needs to be printed in only one color.

The device and the method in accordance with the present invention can be employed, in particular, if it is intended to imprint a web on one side in, for example, four colors, and to imprint the other side of the web in only one color.

With an arrangement of four double printing groups, for rubber-against-rubber operation, in, for example, the form of two H-printing units, the two printing groups of a fifth, additional double printing group are embodied in such a way that they can be operated as offset printing groups during rubber-against-rubber operation, as well as each being individually operated in the direct printing method.

The printing press of the present invention is of particular advantage for use if the double printing group, which is intended for direct printing, is arranged as an additional printing group, and is, for example, also suitable for accomplishing a one-sided or a two-sided flying plate change.

### BRIEF DESCRIPTION OF THE DRAWINGS

Preferred embodiments of the present invention are represented in the drawings and will be described in greater detail in what follows.

Shown are in:

FIG. 1, a first preferred embodiment of a printing press in accordance with the present invention, and showing a first web guidance, in

FIG. 2, a second preferred embodiment of the printing press and showing a second web guidance in the printing press, and

FIG. 3, a third preferred embodiment of the printing press and showing a third web guidance in the printing press in accordance with the present invention.

### DESCRIPTION OF THE PREFERRED EMBODIMENTS

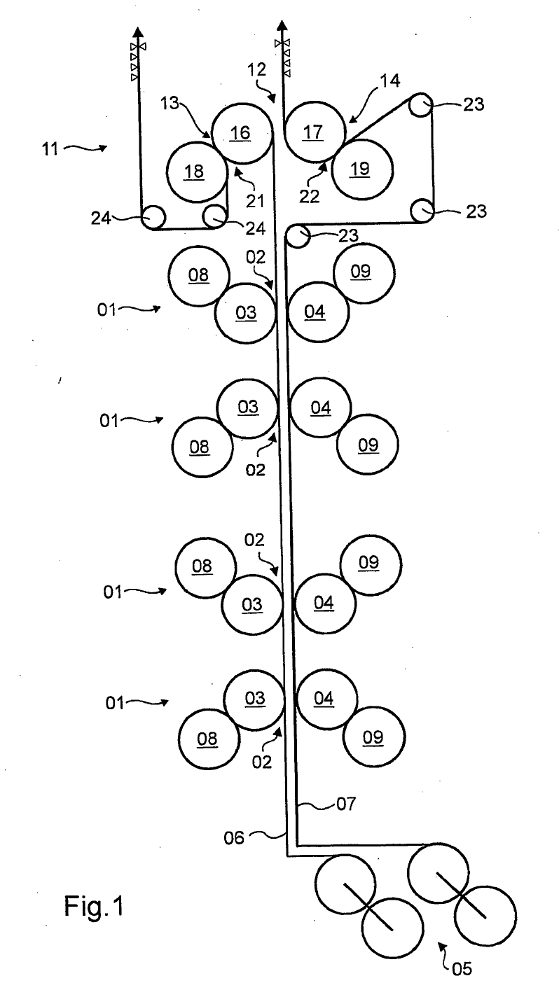

A printing unit of a printing press, and in particular a printing unit of a web-fed rotary printing press is shown schematically in FIG. 1, and has a first double printing group 01. A web 06, 07, or more particularly two webs 06, 07, for example two webs 06, 07 of material, and, in particular, two paper webs 06, 07, can be conducted, in a back to back orientation between two cylinders 03, 04 of the first double printing group 01, which two cylinders 03, 04 are forming a printing gap 02. The webs 06, 07 are supplied by being rolled off roll changers 05, for example.

In the configuration depicted in FIG. 1, the two cylinders 03, 04, forming the printing gap 02, are both embodied as transfer cylinders 03, 04, and in particular are embodied as rubber blanket cylinders 03, 04, to each of which blanket cylinder 03, 04 a further cylinder 08, 09, for example a forme cylinder 08, 09, has been assigned. Inking, and if required, dampening units are provided but are not specifically represented. However, possibly one of the two cylinders 03, 04 forming the printing gap 02 can be embodied as a counter-pressure cylinder 04, 03 which does not conduct printing ink, for example it can be configured as a satellite or a steel cylinder. As a result of this alternate configuration, one of the webs 06, 07 cannot be imprinted in this printing gap 02.

The four cylinders 03, 04, 08, 09 of the printing group 01, which is embodied as a double printing group 01, are rotatably seated or supported with their front ends in a frame, which is not specifically represented. At least one of the two transfer cylinders 03, 04 is seated in the frame in such a way that it is possible to provide a relative positional change of the two transfer cylinders 03, 04 with respect to each other. This change may be, in particular, a change of a distance between the two transfer cylinders 03, 04 for printing operations, for adapting from a single web thickness to the now double web width or thickness, as shown in FIG. 1. For this purpose, a suitable stop, which defines the print-on position of the two transfer cylinders, can be configured to be adjustable. Alternatively, a second, additional stop can be moved into the actuating path of at least one of the two transfer cylinders 03, 04 so that the spacing between the transfer cylinders 03, 04 can be adapted to the thickness of one web or of two webs.

In the first preferred embodiment, shown in FIG. 1, the printing press has four double printing groups 01, each of which is configured corresponding to the first double printing group 01, and which four double printing groups are embodied, for example, in the manner of two H-printing groups that are arranged on top of each other. The double printing groups 01 can also be in the form of 4, or 5 or 6 bridge printing units that are arranged on top of each other.

The two webs 06, 07 can be imprinted in the printing gap 02 of the first double printing group 01, or in the printing gaps 02 of the first four printing groups 01, each respectively on one side. Each web can thus be printed on one side, for example fourfold in four colors or images as is symbolically represented by the four triangles on one side of each web, as seen in FIG. 1. Downstream, viewed in the running direction of the webs 06, 07, of the first double printing group 01, or of the plurality, such as four of the first double printing groups 01, at least one further or additional double printing group 11 with a further or additional printing gap 12 and consisting of two printing groups 13, 14 is provided. In this additional double printing group 11, selectively one of the webs 06, 07 can be imprinted, in the additional printing gap 12 on both sides. Alternatively, both webs 06, 07 can be imprinted, back to back, on one side, as in the first double printing group 01. In a third mode of operation, both webs 06, 07 can each be simultaneously imprinted on the side of that web 06 or 07 which had not been previously imprinted in the first double printing group 01.

In the last described mode of operation, one of the webs 06, 07 can be conducted between a cylinder 16, 17 designed as a transfer cylinder 16, 17, and the associated cylinder 18, 19, respectively designed as forme cylinder 18, 19, and respectively one side of the web can be imprinted by the respective forme cylinder 18, 19 in accordance with the so-called direct lithographic printing process, in printing gaps 21, 22. Even if, in this mode of operation, the cylinder 16, 17 functions as a counter-pressure cylinder 16, 17, and not as a transfer cylinder 16, 17, it is advantageously configured as a transfer cylinder 16, 17 in order to assure the attainment of the two previously mentioned modes of operation for the indirect printing method.

In the area of the further or additional double printing group 11, for use in the direct lithographic printing process, the printing press has, on at least one side, elements 23, such as, for example, guide elements 23, such as, for example, rollers 23 or air-shrouded guide rods 23, by the use of which, at least one of the two incoming webs 07, 06 can be conducted around the forme cylinder 18, 19 of the further or additional double printing group 11, which is located on the side of this web 06, 07 prior to its entry between cylinder 19 and cylinder 17. On the other side of the further or additional double printing group 11, elements 24 are arranged as, for example, rollers 24 or air-shrouded guide rods 24, by the use of which, the other, exiting web 06, 07 can be guided around the forme cylinder 18, 19 of the double printing group 11 located on this side of the web 06, 07 after it exits from between cylinders 16 and 18, all as is seen in FIG. 1.

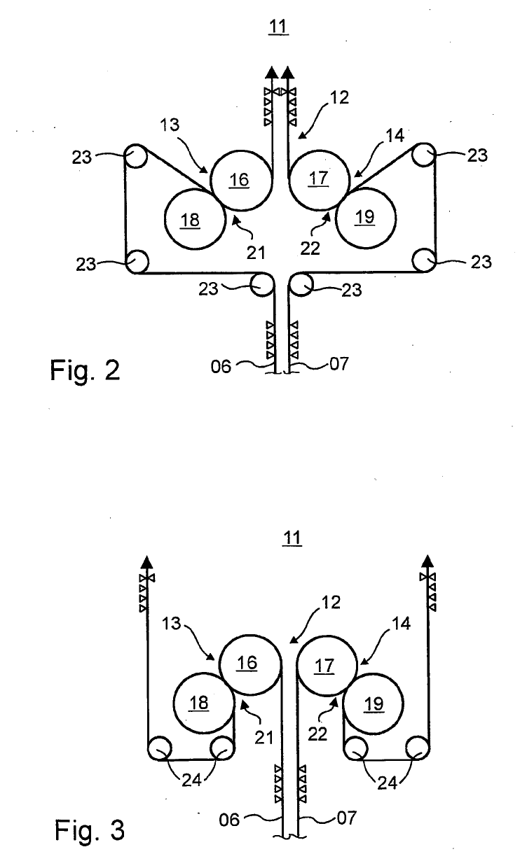

However, as represented in FIGS. 2 and 3, it is also possible to conduct both of the two webs 06, 07 each in the same way around the respective forme cylinder 18, 19, either before they are conducted into, or enter the printing gap 21, 22, as seen in FIG. 2, or after they have left, or exited the printing gap 21, 22, as depicted in FIG. 3.

It is possible, in both of the embodiments shown in FIGS. 2 and 3, to keep the direction of rotation of the cylinders 16, 17, 18, 19 of both printing groups 13, 14 of the further or additional printing group 11, as required for the modes of operation first mentioned above. This can be advantageous, for example, in connection with planographic printing with the use of ink and dampening agents.

In an advantageous embodiment of the present invention, the transfer cylinders 16, 17 of the two printing groups 13, 14 of the further or additional double printing group 11, which can be operated in accordance with the direct lithographic process, are embodied so that they can be spaced apart from each other sufficiently far so that in the third mode of operation, as is depicted in FIG. 3, the two webs 06, 07 do not touch each other in the further printing gap 12. For this purpose, a stop, which is provided for defining the print-on position of the two transfer cylinders, can be structured to be adjustable. Alternatively a second, additional stop can be brought into the actuating path of at least one of the two transfer cylinders.

In an advantageous manner, elements are provided which selectively limit the spacing between the transfer cylinders 16, 17 and the associated forme cylinders 18, 19, in this mode of operation. These elements can again be an adjustably configured stop, which defines the print-on position of the cooperating transfer and forme cylinders 16, 18, 17, 19, respectively, or can be a second stop, which can be additionally brought into the actuating path of at least one of the two transfer cylinders 16, 17.

However, in a further development of the invention, the transfer cylinder 16, 17 has been seated, or supported, in such a way, and its movement toward the forme cylinder 18, 19 can be limited by a stop, in such a way that, in the course of moving or of pivoting the transfer cylinder 16, 17 into the print-on position, in the third mode of operation, sufficient spacing is formed in the printing gap 12, and a suitable printing gap 21, 22 is formed between each of the forme and transfer cylinders 16, 18, 17, 19, respectively.

In an advantageous embodiment of the present invention, each of the two printing groups 13, 14 in the further or additional double printing group 11 have at least their own drive motor, which is not specifically represented, for rotatory driving the printing groups. With such a respective drive in pairs, the motor can either drive the forme cylinder 18, 19, or both cylinders 16, 17, 18, 19 parallel, or the transfer cylinder 16, 17. A drive motor for each of the four cylinders 16, 17, 18, 19 can also be arranged, if desired.

The further or additional double printing group 11, which can be selectively operated in the direct lithographic process or in the offset process, preferably constitutes the last printing group 01 through which the web 06, 07 runs. It is assured, in this way, that the webs 06, 07 are not imprinted on this side, as long as they pass back to back through the first double printing groups 01.

In the first preferred embodiment, which is represented in FIG. 1, the four first double printing groups 01, and the further or additional double printing group 11 are embodied as a so-called “tower of ten”. The uppermost, further or additional double printing group 11, which is configured as a bridge printing unit 11, can be used, for example, for imprinting one of the web 06, 07, or both of the webs, with a decorative color. It is moreover advantageous if the transfer cylinders 03, 04, 16, 17, which are assigned to each other, of at least two of the five double printing groups 01, 11 can be spaced apart from each other so that a web 06, 07 moving at production speed can be conducted between them without touching. In this case, by the use of the printing press configured in this way as, for example a tower of ten, it is possible to selectively imprint
one web on both sides in five colors 5/5,
two webs each on one side with five colors 5/0 or 0/5,
two webs each with sides with respectively four and one color 4/1 or 1/4,
one web by the use of an imprint process with 4/4 print.

In a further variation of the present invention, which is not specifically represented, a web 06, 07, which has previously been imprinted on one side by an offset process in one or in several of the first double printing groups 01, is conducted directly in the printing gap 21, 22, i.e. on the side of the printing gap 21 or 22 that is facing the most upstream located one of the double printing group 01. This web 06, 07 is then provided, in this printing gap 21 or 22, with an additional imprint, such as, for example a decorative color, or the like on its already imprinted side.

While preferred embodiments of a printing press and of methods for printing two webs, in accordance with the present invention, have been set forth fully and completely hereinabove, it will be apparent to one of skill in the art that various changes in, for example, the structure of the forme cylinders, the roll supports for the webs and the like could be made without departing from the true spirit and scope of the present invention which is accordingly to be limited only by the appended claims.

1-15. (canceled)

16. A printing press adapted for the simultaneous printing of first and second webs comprising:
at least one first double printing group;
a first printing gap defined by said at least one first double printing group, said first and second webs being conducted back to back through said first double printing group, each of said first and second webs being printed on a first web side in said first printing gap;
a further double printing group having first and second printing groups adapted for rubber-against-rubber printing, each of said first and second printing groups including a transfer cylinder and a forme cylinder, at least one of said first and second webs being conducted between said transfer cylinder and said forme cylinder of at least one of said first and second printing groups for direct printing on one of said first and a second side of said web by said forme cylinder.

17. The printing press of claim 16 wherein in said further double printing group both of said first and second webs are each conducted between a separate forme cylinder and transfer cylinder of said first and second printing groups.

18. The printing press of claim 16 further including four of said first double printing groups arranged in a running direction of said first and second webs.

19. The printing press of claim 16 wherein said first and second printing groups in said further double printing group each constitutes a last printing gap.

20. The printing press of claim 18 wherein said four first double printing groups form two H-shaped printing units arranged on top of each other.

21. The printing press of claim 16 wherein said further double printing group is a bridge printing unit.

22. The printing press of claim 16 further including a first drive motor for said first printing group and a second drive motor for said second printing group of said further double printing group.

23. The printing press of claim 16 further including a separate, independent drive motor for each of said transfer cylinders and each of said forme cylinders for each of said first and second printing groups of said further double printing group.

24. The printing press of claim 16 further including guide elements in at least one of said first and second printing groups of said further double printing group and adapted to conduct said one of said first and second webs entering said one of said first and second printing groups around said forme cylinder of said one of said first and second printing groups.

25. The printing press of claim 16 further indicating guide elements in at least one of said first and second printing groups of said further double printing group and adapted to conduct said one of said first and second webs leaving said one of said first and second printing groups around said forme cylinder of said one of said first and second printing groups.

26. A method for simultaneously printing at least first and second webs including:
providing at least a first double printing group;
forming a first printing gap in said at least first double printing group;
conducting said first and second webs back to back through said first printing gap of said at least first double printing group;
printing each of said first and second webs on a first side in said first printing gap;
providing a further double printing group having first and second printing groups;
providing a transfer cylinder and a forme cylinder in each of said first and second printing groups;
conducting at least one of said first and second webs between said transfer cylinder and said forme cylinder of one of said first and second printing groups; and
directly imprinting said at least one of said first and second webs on one side by said forme cylinder.

27. The method of claim 26 further including passing one of said webs between said transfer cylinder and said forme cylinder of one of said first and second printing groups and passing the other of said webs between said transfer cylinder and said forme cylinder of the other of said first and second printing groups.

28. The method of claim 26 further including conducting said at least one web entering a second printing gap defined by said transfer cylinder and said forme cylinder of said one of said first and second printing groups around said forme cylinder before entering said second printing gap.

29. The method of claim 26 further including conducting said at least one web entering a second printing gap defined by said transfer cylinder and said forme cylinder of said one of said first and second printing groups around said transfer cylinder before entering said second printing gap.

30. The method of claim 26 further including defining a second printing gap between said transfer cylinder and said forme cylinder of said further double printing group and passing one of said first and second webs coming from said first double printing group directly into said second printing gap of one of said first and second printing groups facing said first double printing group.
